(19) United States
(12) Patent Application Publication
(10) Pub. No.: US 2010/0169906 A1
(43) Pub. Date: Jul. 1, 2010

(54) User-Annotated Video Markup

(75) Inventor: Eduardo S. C. Takahashi, Mountain View, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/345,843

(22) Filed: Dec. 30, 2008

(51) Int. Cl. H04H 60/33

(52) U.S. Cl. 725/13

(57) ABSTRACT

User-annotated video markup is described. In embodiments, recorded video content can be rendered for display, and an annotation input can be received that is associated with a displayed segment of the recorded video content. The annotation input can be synchronized with synchronization data that corresponds to the displayed segment of the recorded video content, and then a video markup data file can be generated that includes the annotation input, the synchronization data, and a reference to the recorded video content.

### BACKGROUND

Viewers have an ever-increasing selection of media content to choose from, such as recorded movies, videos, and other video-on-demand selections that are available for viewing. Given the large volume of the various types of media content to choose from, viewers may seek recommendations for movies and other recorded video content from other users that post reviews and recommendations on personal Web pages, blogs, and social networking sites. Alternatively, a viewer may watch a particular movie, and then post a review or recommendation on-line for others to read.

### SUMMARY

This summary is provided to introduce simplified concepts of user-annotated video markup. The simplified concepts are further described below in the Detailed Description. This summary is not intended to identify essential features of the claimed subject matter, nor is it intended for use in determining the scope of the claimed subject matter.

User-annotated video markup is described. In embodiments, recorded video content can be rendered for display, and an annotation input can be received that is associated with a displayed segment of the recorded video content. The annotation input can be synchronized with synchronization data that corresponds to the displayed segment of the recorded video content, and then a video markup data file can be generated that includes the annotation input, the synchronization data, and a reference to the recorded video content.

In other embodiments of user-annotated video markup, an annotation input can add context information that is associated with a displayed segment of the recorded video content, however the recorded video content is not modified when the video markup data file is generated. An annotation input can be received to include display content, display position data associated with the display content, and a display time that indicates a display duration of the display content. The display content can include any one or combination of text, an image, a graphic, audio, video, a hyperlink, a reference, or shortcut to another scene in the recorded video content or other video content. The video markup data file can be communicated to a content distributor or other storage service that maintains the video markup data file for on-demand requests along with the recorded video content that may also be received as a requested video-on-demand.

### BRIEF DESCRIPTION OF THE DRAWINGS

Embodiments of user-annotated video markup are described with reference to the following drawings. The same numbers are used throughout the drawings to reference like features and components:

FIG. 1 illustrates an example system in which embodiments of user-annotated video markup can be implemented.

FIG. 2 illustrates another example system in which embodiments of user-annotated video markup can be implemented.

FIG. 3 illustrates example method(s) for user-annotated video markup in accordance with one or more embodiments.

FIG. 4 illustrates various components of an example device that can implement embodiments of user-annotated video markup.

### DETAILED DESCRIPTION

Embodiments of user-annotated video markup provide that a user can annotate recorded video content to create a personalized and enhanced view of the video content, but without modification to the original content. Recorded video content can include many types of recorded video, such as videos-on-demand, movies, sporting events, recorded television programs, family vacation video, and the like. While viewing recorded video, a user can enter annotation inputs such as any type of commentary, visual feature, and/or context information that is associated with a displayed segment of the recorded video to enhance the recorded video.

A video sequence of recorded video content can be marked-up with any number of multimedia enhancements and display content, such as text, images, audio, video, a shortcut to another scene in the recorded video content or other video content, and/or graphics to include, but not limited to, balloon pop-ups, symbols, drawings, sticky notes, hyperlinks, references, still pictures, user-defined context, and the like. The display content can be selected and edited to overlay the recorded video content. In various examples, a user may annotate recorded video of a football game to provide stats for players, as a coach's tool to review and prepare for another game, as a spectator to highlight the football during a controversial referee call, or as an educational tool to annotate the rules of the game over the video to illustrate applications of the rules.

The various annotation inputs from a user can then be stored in a data file that also includes synchronization data to synchronize the annotation inputs with the displayed segments of the recorded video content. The data file can then be uploaded and is shareable among other users and subscribers that may request to view the recorded content along with the annotation inputs and commentary created by another user.

While features and concepts of the described systems and methods for user-annotated video markup can be implemented in any number of different environments, systems, and/or various configurations, embodiments of user-annotated video markup are described in the context of the following example systems and environments.

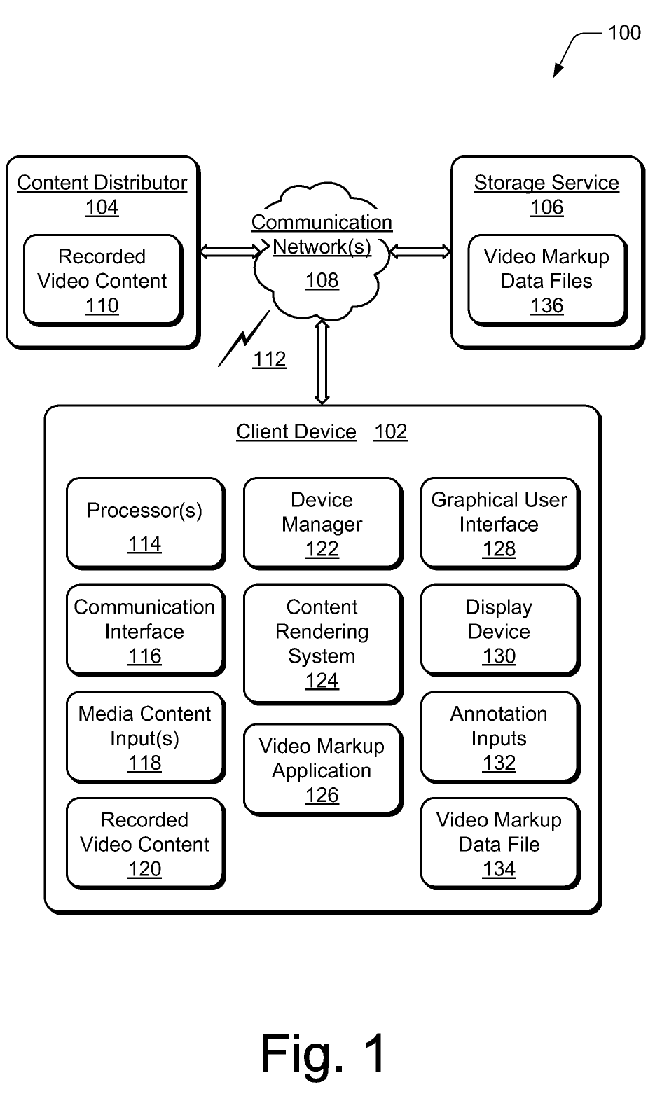

FIG. 1 illustrates an example system 100 in which various embodiments of user-annotated video markup can be implemented. Example system 100 includes an example client device 102, a content distributor 104, and a storage service 106 that are all implemented for communication via communication networks 108. The client device 102 (e.g., a wired and/or wireless device) is an example of any one or combination of a television client device (e.g., a television set-top box, a digital video recorder (DVR), etc.), computer device, portable computer device, gaming system, appliance device, media device, communication device, electronic device, and/or as any other type of device that can be implemented to receive media content in any form of audio, video, and/or image data.

In a media content distribution system, the content distributor 104 facilitates distribution of recorded video content 110, television media content, content metadata, and/or other associated data to multiple viewers, users, customers, subscribers, viewing systems, and/or client devices. The example client device 102, content distributor 104, and storage service 106 are implemented for communication via communication networks 108 that can include any type of a data network, voice network, broadcast network, an IP-based network, and/or a wireless network 112 that facilitates communication of data in any format. The communication networks 108 and wireless network 112 can be implemented using any type of network topology and/or communication protocol, and can be represented or otherwise implemented as a combination of two or more networks. In addition, any one or more of the arrowed communication links facilitate two-way data communication.

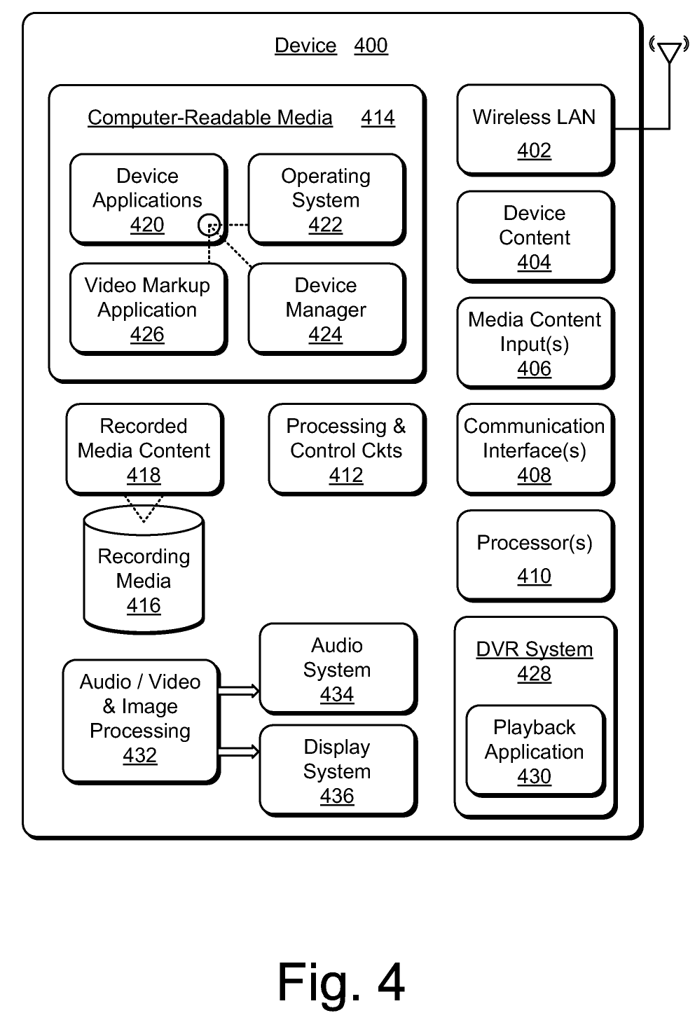

In this example system 100, client device 102 includes one or more processors 114 (e.g., any of microprocessors, controllers, and the like), a communication interface 116 for data communications, and/or media content inputs 118 to receive media content from content distributor 104, such as recorded video content 120. Client device 102 also includes a device manager 122 (e.g., a control application, software application, signal processing and control module, code that is native to a particular device, a hardware abstraction layer for a particular device, etc.). Client device 102 can also be implemented with any number and combination of differing components as described with reference to the example device shown in FIG. 4.

Client device 102 includes a content rendering system 124 to receive and render the recorded video content 120 for display. The recorded video content 120 can be received from the content distributor 104 as a requested video-on-demand. Alternatively, the recorded video content 120 at client device 102 can be recorded home video, or other user-recorded video.

Client device 102 also includes a video markup application 126 that can be implemented as computer-executable instructions and executed by the processors 114 to implement various embodiments and/or features of user-annotated video markup. In an embodiment, the video markup application 126 can be implemented as a component or module of the device manager 122. The video markup application 126 can initiate display of a graphical user interface 128 that is displayed on a display device 130 for user interaction to initiate annotation inputs 132 that are associated with a displayed segment of the recorded video content. The display device 130 can be implemented as any type of integrated display or external television, LCD, or similar display system.

An annotation input 132 can include any type of commentary, visual feature, and/or context information that is associated with a displayed segment of the recorded video content to enhance the recorded video content. A user can markup a video sequence of recorded video content with any number of multimedia enhancements and display content, such as text, images, audio, video, a shortcut to another scene in the recorded video content or other video content, and/or graphics to include, but not limited to, balloon pop-ups, symbols, drawings, sticky notes, hyperlinks, references, still pictures, user-defined context, and the like. In an implementation, a shortcut can provide a reference or jump point in an annotation input to jump to another scene in the same recorded video content (e.g., to the next scoring play in a football game, or to a key plot event in a movie), or jump to a scene or event in other recorded video content. The display content can be selected and edited to overlay the recorded video content from the graphical user interface 128, such as from drop-down menus, toolbars, and from any other various selection techniques.

An annotation input 132 can be initiated with an input device, such as with a mouse or other pointing device at a computer, or can be initiated with a remote control device at a television client device. For example, a user can utilize video control inputs, such as fast-forward, rewind, and pause to then access a particular segment of recorded video content for annotation and commentary. In various examples, a user may annotate recorded video of a football game to provide stats for players, as a coach's tool to review and prepare for another game, as a spectator to highlight the football during a controversial referee call, or as an educational tool to annotate the rules of the game over the video to illustrate applications of the rules. Many other examples of video annotation can be realized for many types of recorded video, such as sporting events, movies, recorded television programs, family vacation video, as a replacement for closed caption, situational or history context, and the like.

Each annotation input 132 that is received via the graphical user interface 128 can include at least the display content, display position data associated with the display content, and a display time that indicates a display duration of the display content. In addition, each annotation input 132 can be associated with a specific frame, sequence of frames, and/or segment of the recorded video content. The display position data can include video stream embedded timing and/or position synchronization data to correlate an annotation input for display. For example, the display position data can include frame and/or relative pixel location data to correlate display content on a display screen, and data for time synchronization of an overlay markup (e.g., display content) and original video on-demand content.

In embodiments, the video markup application 126 can be implemented to generate a video markup data file 134 that can include at least the annotation inputs 132 that are associated with recorded video content 120, the synchronization data, and an identifier or reference to the recorded video content. The video markup application 126 generates the video markup data file 134 without modification to the recorded video content and without needing to decipher the encryption protection of the recorded video content. The annotations, markup, and synchronization data are external to the original recorded video content and can be maintained in a video markup data file that is independent of the recorded video content.

In embodiments, the video markup application 126 can also be implemented to initiate communication of the video markup data file 134 to the content distributor 104 and/or to the storage service 106 that maintains stored video markup data files 136 which can then be requested along with on-demand request for the recorded video content 110. The stored video markup data files 136 are uploaded and shareable among users and subscribers in a media content distribution system. Although the content distributor 104 and the storage service 106 are illustrated as separate entities, the content distributor 104 can include the storage service and/or the stored video markup data files 136 in other embodiments. When the recorded video content 110 is requested as a video on-demand from the content distributor 104, the content distributor can also communicate stored video markup data files 136 that are requested along with the recorded video content, such as communicated in-band or out-of-band to a requesting client device.

For more capable client devices, the overlay markup data (e.g., in a video markup data file) can be sent out-of-band as a burst at the beginning of a video-on-demand. The client device can then interpret the overlay markup data and synchronize it with the video-on-demand stream. For less capable client devices, a video-on-demand server at the content distributor 104 can include stored video markup data files 136 in the transport stream as a private data elementary stream with timestamps that correlate to presentation times of the recorded video content. The client device can then interpret and render the overlay data for display as it is received.

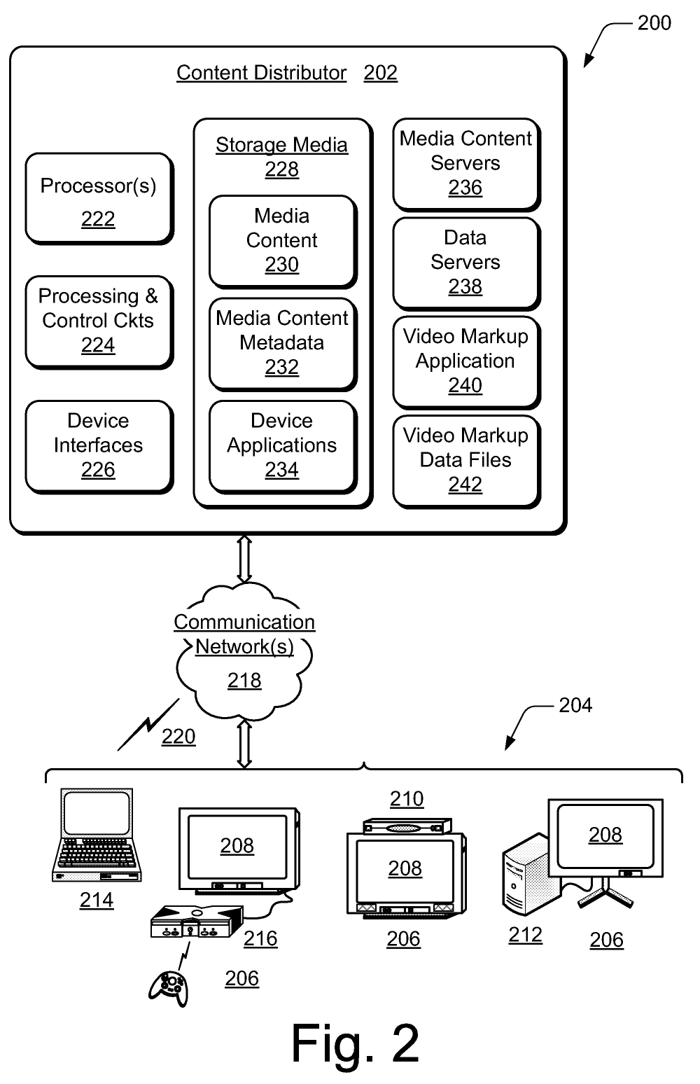

FIG. 2 illustrates another example system 200 in which various embodiments of user-annotated video markup can be implemented. Example system 200 includes a content distributor 202 and various client devices 204 that are implemented to receive media content from the content distributor 202. An example implementation of a client device 204 is described with reference to FIG. 1. Example system 200 may also include other data or content sources that distribute any type of data or content to the various client devices 204. The client devices 204 (e.g., wired and/or wireless devices) can be implemented as components in various client systems 206. Each of the client systems 206 include a respective client device and display device 208 that together render or playback any form of audio, video, and/or image content.

A display device 208 can be implemented as any type of a television, high definition television (HDTV), LCD, or similar display system. The various client devices 204 can include local devices, wireless devices, and/or other types of networked devices. A client device in a client system 206 can be implemented as any one or combination of a television client device 210 (e.g., a television set-top box, a digital video recorder (DVR), etc.), computer device 212, portable computer device 214, gaming system 216, appliance device, media device, communication device, electronic device, and/or as any other type of device that can be implemented to receive media content in any form of audio, video, and/or image data in a media content distribution system.

Any of the client devices described herein can be implemented with one or more processors, communication components, data inputs, memory components, processing and control circuits, and/or a media content rendering system. A client device can also be implemented with any number and combination of differing components as described with reference to the example device shown in FIG. 1 and/or the example device shown in FIG. 4. The various client devices 204 and the sources that distribute media content are implemented for communication via communication networks 218 and/or a wireless network 220 as described with reference to FIG. 1.

In a media content distribution system, the content distributor 202 facilitates distribution of video content, television media content, content metadata, and/or other associated data to multiple viewers, users, customers, subscribers, viewing systems, and/or client devices. Content distributor 202 can receive media content from various content sources, such as a content provider, an advertiser, a national television distributor, and the like. The content distributor 202 can then communicate or otherwise distribute the media content to any number of the various client devices. In addition, the content distributor 202 and/or other media content sources can include a proprietary media content distribution system to distribute media content in a proprietary format.

Media content (e.g., to include recorded media content) can include any type of audio, video, and/or image media content received from any media content source. As described herein, media content can include recorded video content, video-on-demand content, television media content, television programs (or programming), advertisements, commercials, music, movies, video clips, and on-demand media content. Other media content can include interactive games, network-based applications, and any other content (e.g., to include program guide application data, user interface data, advertising content, closed captions data, content metadata, search results and/or recommendations, and the like).

In this example system 200, content distributor 202 includes one or more processors 222 (e.g., any of microprocessors, controllers, and the like) that process various computer-executable instructions to implement embodiments of user-annotated video markup. Alternatively or in addition, content distributor 202 can be implemented with any one or combination of hardware, firmware, or fixed logic circuitry that is implemented in connection with processing and control circuits which are generally identified at 224. Although not shown, content distributor 202 can include a system bus or data transfer system that couples the various components within the service.

Content distributor 202 also includes one or more device interfaces 226 that can be implemented as a serial and/or parallel interface, a wireless interface, any type of network interface, a modem, and/or as any other type of communication interface. The device interfaces 226 provide connection and/or communication links between content distributor 202 and the communication networks 218 by which to communicate with the various client devices 204.

Content distributor 202 also includes storage media 228 to store or otherwise maintain media content 230, media content metadata 232, and/or other data for distribution to the various client devices 204. The media content 230 can include recorded video content, such as video-on-demand media content. The media content metadata 232 can include any type of identifying criteria, descriptive information, and/or attributes associated with the media content 230 that describes and/or categorizes the media content. In a Network Digital Video Recording (nDVR) implementation, recorded on-demand content can be recorded when initially distributed to the various client devices as scheduled television media content, and stored with the storage media 228 or other suitable storage device.

The storage media 228 can be implemented as any type of memory, magnetic or optical disk storage, and/or other suitable electronic data storage. The storage media 228 can also be referred to or implemented as computer-readable media, such as one or more memory components, that provide data storage for various device applications 234 and any other types of information and/or data related to operational aspects of the content distributor 202. For example, an operating system and/or software applications and components can be maintained as device applications with the storage media 228 and executed by the processors 222. Content distributor 202 also includes media content servers 236 and/or data servers 238 that are implemented to distribute the media content 230 and other types of data to the various client devices 204 and/or to other subscriber media devices.

Content distributor 202 includes a video markup application 240 that can be implemented as computer-executable instructions and executed by the processors 222 to implement embodiments of user-annotated video markup. In an implementation, the video markup application 240 is an example of a device application 234 that is maintained by the storage media 228. Although illustrated and described as a component or module of content distributor 202, the video markup application 240, as well as other functionality to implement the various embodiments described herein, can be provided as a service apart from the content distributor 202 (e.g., on a separate server or by a third party service).

Content distributor 202 also includes video markup data files 242 that have been generated and uploaded by the various client devices 204. The video markup application 240 at content distributor 202 can be implemented to correlate a video markup data file 242 with recorded video content that is requested as a video-on-demand from a client device, and communicate the video markup data file 242 to the client device for viewing along with the video-on-demand. Various ones of the video markup data files 242 can be requested by a user, such as video markup data files that are generated by different sources, such as other subscribers, users, and/or friends of a user that generate the video markup data files.

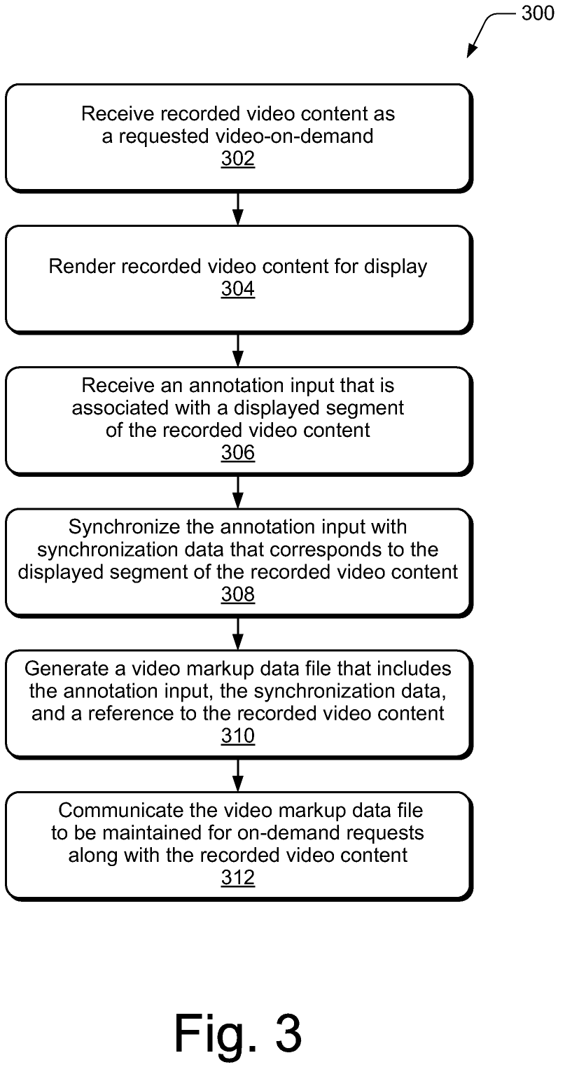

Example method 300 is described with reference to FIG. 3 in accordance with one or more embodiments of user-annotated video markup. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The method(s) may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of user-annotated video markup. The order in which the method is described is not intended to be construed as a limitation, and any number of the described method blocks can be combined in any order to implement the method, or an alternate method.

At block 302, recorded video content is received as a requested video-on-demand and, at block 304, the recorded video content is rendered for display. For example, client device 102 (FIG. 1) receives recorded video content 110 from content distributor 104 when requested as a video-on-demand, and content rendering system 124 renders the recorded video content for display. Alternatively, the recorded video content can be rendered for display as any type of requested or user-generated video.

At block 306, an annotation input is received that is associated with a displayed segment of the recorded video content. For example, the video markup application 126 initiates the graphical user interface 128 that is displayed on a display device 130 for user interaction to initiate an annotation input 132 that is associated with a displayed segment of the recorded video content. The video markup application 126 receives annotation inputs that add context information and that are associated with the displayed segment of the recorded video content. The annotation inputs can be received to include display content, display position data associated with the display content, and a display time that indicates a display duration of the display content.

At block 308, the annotation input is synchronized with synchronization data that corresponds to the displayed segment of the recorded video content. For example, the video markup application 126 at client device 102 synchronizes each annotation input 132 with video stream embedded timing and/or position synchronization data to associate an annotation input with a specific frame, sequence of frames, and/or segment of the recorded video content.

At block 310, a video markup data file is generated that includes the annotation input, the synchronization data, and a reference to the recorded video content. For example, the video markup application 126 at client device 102 generates a video markup data file 134 that includes at least the annotation inputs 132 that are associated with recorded video content 120, the synchronization data, and an identifier or reference to the recorded video content. The video markup application 126 also generates the video markup data file 134 without modification to the recorded video content, and without modification to the encryption protection of the recorded video content.

At block 312, the video markup data file is communicated to be maintained for on-demand requests along with the recorded video content. For example, the video markup application 126 initiates communication of the video markup data file 134 to the content distributor 104 and/or to the storage service 106 that maintains stored video markup data files 136 which can then be requested along with on-demand request for the recorded video content 110. The stored video markup data files 136 are uploaded and shareable among users and subscribers in a media content distribution system.

The method can continue such that the video markup application 126 at client device 102 receives an additional video markup data file 136 that is associated with the recorded video content 120. A user can request a stored video markup data file 136 that is created by another user and append additional annotation inputs to create a collaborative video markup data file. The video markup application 126 can then generate the video markup data file 134 to include the additional video markup data file, such as when correlating annotation inputs from the additional video markup data file with the recorded video content to render the recorded video content for display with the annotation inputs.

FIG. 4 illustrates various components of an example device 400 that can be implemented as any type of device as described with reference to FIG. 1 and/or FIG. 2 to implement embodiments of user-annotated video markup. In embodiment(s), device 400 can be implemented as any one or combination of a wired and/or wireless device, portable computer device, media device, computer device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes wireless LAN (WLAN) components 402, that enable wireless communication of device content 404 or other data (e.g., received data, data that is being received, data scheduled for broadcast, data packets of the data, etc.). The device content 404 can include configuration settings of the device, media content stored on the device, and/or information associated with a user of the device. Device 400 can also include one or more media content input(s) 406 via which any type of media content can be received, such as music, television media content, recorded video content, and any other type of audio, video, and/or image content received from a content source which can be processed, rendered, and/or displayed for viewing.

Device 400 can also include communication interface(s) 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices can communicate data with device 400.

Device 400 can include one or more processors 410 (e.g., any of microprocessors, controllers, and the like) which process various computer-executable instructions to control the operation of device 400 and to implement embodiments of user-annotated video markup. Alternatively or in addition, device 400 can be implemented with any one or combination of hardware, firmware, or fixed logic circuitry that is implemented in connection with processing and control circuits which are generally identified at 412.

Device 400 can also include computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 400 may also include a recording media 416 to maintain recorded media content 418 that device 400 receives and/or records.

Computer-readable media 414 provides data storage mechanisms to store the device content 404, as well as various device applications 420 and any other types of information and/or data related to operational aspects of device 400. For example, an operating system 422 can be maintained as a computer application with the computer-readable media 414 and executed on the processors 410. The device applications 420 can also include a device manager 424 and a video markup application 426. In this example, the device applications 420 are shown as software modules and/or computer applications that can implement various embodiments of user-annotated video markup.

When implemented as a television client device, the device 400 can also include a DVR system 428 with a playback application 430 that can be implemented as a media control application to control the playback of recorded media content 418 and/or any other audio, video, and/or image content that can be rendered and/or displayed for viewing. The recording media 416 can maintain recorded media content that may include media content when it is received from a content distributor and recorded. For example, media content can be recorded when received as a viewer-scheduled recording, or when the recording media 416 is implemented as a pause buffer that records streaming media content as it is being received and rendered for viewing.

Device 400 can also include an audio, video, and/or image processing system 432 that provides audio data to an audio system 434 and/or provides video or image data to a display system 436. The audio system 434 and/or the display system 436 can include any devices or components that process, display, and/or otherwise render audio, video, and image data. The audio system 434 and/or the display system 436 can be implemented as integrated components of the example device 400. Alternatively, audio system 434 and/or the display system 436 can be implemented as external components to device 400. Video signals and audio signals can be communicated from device 400 to an audio device and/or to a display device via an RF (radio frequency) link, S-video link, composite video link, component video link, DVI (digital video interface), analog audio connection, or other similar communication link.

Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of user-annotated video markup have been described in language specific to features and/or methods, it is to be understood that the subject of the appended claims is not necessarily limited to the specific features or methods described. Rather, the specific features and methods are disclosed as example implementations of user-annotated video markup.

1. A method, comprising:
rendering recorded video content for display;
receiving an annotation input that is associated with a displayed segment of the recorded video content;
synchronizing the annotation input with synchronization data that corresponds to the displayed segment of the recorded video content; and
generating a video markup data file that includes at least the annotation input, the synchronization data, and a reference to the recorded video content.

2. A method as recited in claim 1, further comprising communicating the video markup data file to be maintained for on-demand requests along with the recorded video content.

3. A method as recited in claim 1, wherein the recorded video content is not modified when the video markup data file is generated.

4. A method as recited in claim 1, wherein the annotation input includes context information that is associated with the displayed segment of the recorded video content.

5. A method as recited in claim 1, wherein the annotation input is received to include display content, display position data associated with the display content, and a display time that indicates a display duration of the display content.

6. A method as recited in claim 5, wherein the display content is at least one of text, an image, audio, video, a shortcut, a hyperlink, or a graphic.

7. A method as recited in claim 1, further comprising receiving the recorded video content as a requested video-on-demand.

8. A method as recited in claim 7, further comprising:
receiving an additional video markup data file that is associated with the recorded video content; and
generating the video markup data file to include the additional video markup data file.

9. A method as recited in claim 8, further comprising correlating an additional annotation input from the additional video markup data file with the recorded video content to render the recorded video content for display with the additional annotation input.

10. A video markup system, comprising:
a content rendering system configured to render recorded video content for display;
a user interface configured for user interaction to initiate an annotation input that is associated with a displayed segment of the recorded video content;
a video markup application configured to:
synchronize the annotation input with synchronization data that corresponds to the displayed segment of the recorded video content; and
generate a video markup data file that includes at least the annotation input, the synchronization data, and a reference to the recorded video content.

11. A video markup system as recited in claim 10, wherein the video markup application is further configured to initiate communication of the video markup data file to be maintained for on-demand requests along with the recorded video content.

12. A video markup system as recited in claim 10, wherein the video markup application is further configured to generate the video markup data file without modification to the recorded video content.

13. A video markup system as recited in claim 10, wherein the video markup application is further configured to receive the annotation input as context information that is associated with the displayed segment of the recorded video content.

14. A video markup system as recited in claim 10, wherein the video markup application is further configured to receive the annotation input that includes display content, display position data associated with the display content, and a display time that indicates a display duration of the display content.

15. A video markup system as recited in claim 14, wherein the display content is at least one of text, an image, or a graphic.

16. A video markup system as recited in claim 10, further comprising a media content input configured to receive the recorded video content as a requested video-on-demand.

17. Computer-readable media comprising computer-executable instructions that, when executed, initiate a video markup application to:
receive an annotation input that is associated with a displayed segment of recorded video content;
synchronize the annotation input with synchronization data that corresponds to the displayed segment of the recorded video content; and
generate a video markup data file that includes at least the annotation input, the synchronization data, and a reference to the recorded video content.

18. Computer-readable media as recited in claim 17, further comprising computer-executable instructions that, when executed, initiate the video markup application to initiate communication of the video markup data file to be maintained for on-demand requests along with the recorded video content.

19. Computer-readable media as recited in claim 17, further comprising computer-executable instructions that, when executed, initiate the video markup application to receive the annotation input as including display content, display position data associated with the display content, and a display time that indicates a display duration of the display content.

20. Computer-readable media as recited in claim 17, further comprising computer-executable instructions that, when executed, initiate the video markup application to initiate display of a user interface for user interaction via which the annotation input is received and associated with the displayed segment of the recorded video content.
